(19) United States
(12) Patent Application Publication
(10) Pub. No.: US 2024/0232032 A1
(43) Pub. Date: Jul. 11, 2024

(54) STREAM TEMPERATURE INTERLEAVE MONITOR

(71) Applicant: Western Digital Technologies, Inc., San Jose, CA (US)

(72) Inventors: LIAT HOD, Kfar Saba (IL); OMER GILAD, Holon (IL); RAFI PAZ, Tel Aviv (IL); EINAV ZILBERSTEIN, Had Hasharon (IL); EYAL SOBOL, Givat Shmuel (IL); JUDAH GAMLIEL HAHN, Ofra (IL)

(73) Assignee: Western Digital Technologies, Inc., San Jose, CA (US)

(21) Appl. No.: 18/448,406

(22) Filed: Aug. 11, 2023

Related U.S. Application Data
(60) Provisional application No. 63/437,981, filed on Jan. 9, 2023.

(51) Int. Cl. G06F 11/30; G06F 11/32

(52) U.S. Cl. CPC G06F 11/3037; G06F 11/324

(57) ABSTRACT

A non-volatile memory device that performs stream temperature interleave monitoring includes a plurality of regions of non-volatile memory and a controller. The controller is configured to monitor different access frequencies for data received by the non-volatile memory device. The controller is configured to determine interleave metrics indicating amounts of data of different access frequencies stored by each of the plurality of regions of non-volatile memory. The controller is configured to perform a subsequent action for the non-volatile memory device based on the determined interleave metrics.

### CROSS-REFERENCES TO RELATED APPLICATIONS

This application claims the benefit of U.S. Provisional Patent Application No. 63/437,981 entitled “STREAM TEMPERATURE INTERLEAVE MONITOR” and filed on Jan. 9, 2023, for Liat Hod et al., which is incorporated herein by reference.

### TECHNICAL FIELD

The present disclosure, in various embodiments, relates to non-volatile memory and more particularly relates to a stream temperature interleave monitor for non-volatile memory.

### BACKGROUND

Context for data, such as an indication as to how often the data is likely to be read, overwritten, or the like, can improve a memory device's ability to efficiently manage the data. Even when context information is available, however, some memory devices, such as memory cards, memory for automobiles or other embedded devices, or the like, may not have the resources and/or capacity to manage data storage based on context information.

### SUMMARY

Apparatuses are presented for stream temperature interleave monitoring. An apparatus, in one embodiment, includes a non-volatile memory device comprising a plurality of regions of non-volatile memory. In some embodiments, the apparatus includes a controller. The controller, in certain embodiments, is configured to monitor different access frequencies for data received by the non-volatile memory device. The controller, in a further embodiment, is configured to determine interleave metrics indicating amounts of data of different access frequencies stored by each of the plurality of regions of non-volatile memory. The controller, in some embodiments, is configured to perform a subsequent action for the non-volatile memory device based on the determined interleave metrics.

Methods are presented for stream temperature interleave monitoring. In one embodiment, a method includes tracking different access frequencies for data stored by a non-volatile memory device comprising a plurality of blocks. The method, in certain embodiments, includes determining ratios of interleaved data of different access frequencies stored by each of the plurality of blocks. The method, in a further embodiment, includes performing an action for the non-volatile memory device based on the determined ratios of interleaved data.

An apparatus, in another embodiment, includes means for stream temperature interleave monitoring. In certain embodiments, the apparatus includes means for monitoring different access frequencies for data received by a non-volatile memory device comprising a plurality of regions of non-volatile memory. The apparatus, in some embodiments, includes means for determining interleave metrics indicating amounts of data of different access frequencies stored by each of the plurality of regions of non-volatile memory. In one embodiment, the apparatus includes means for performing a subsequent action for the non-volatile memory device based on the determined interleave metrics.

### BRIEF DESCRIPTION OF THE DRAWINGS

A more particular description is included below with reference to specific embodiments illustrated in the appended drawings. Understanding that these drawings depict only certain embodiments of the disclosure and are not therefore to be considered limiting of the scope of the disclosure, the disclosure is described and explained with additional specificity and detail through the use of the accompanying drawings, in which:

FIG. 1 is a schematic block diagram illustrating one embodiment of a system comprising non-volatile memory elements;

FIG. 2 is a schematic block diagram illustrating another embodiment of a system comprising non-volatile memory elements;

FIG. 3 depicts cyclic, sequential storage operation on a non-volatile storage device according to one embodiment;

FIG. 4 is a schematic block diagram illustrating an embodiment of a system for saving data in non-volatile memory elements;

FIG. 5 is a schematic block diagram illustrating an embodiment of a system for saving data in non-volatile memory elements;

FIG. 6 is a schematic block diagram illustrating an embodiment of a temperature monitor component;

FIG. 7 is a schematic block diagram illustrating one embodiment of a graphical representation of interleave metrics;

FIG. 8 is a schematic flow chart diagram illustrating one embodiment of a method for stream temperature interleave monitoring;

FIG. 9 is a schematic flow chart diagram illustrating a further embodiment of a method for stream temperature interleave monitoring; and

FIG. 10 is a schematic flow chart diagram illustrating a certain embodiment of a method for stream temperature interleave monitoring.

### DETAILED DESCRIPTION

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module.” “apparatus,” or “system.” Furthermore, aspects of the present disclosure may take the form of a computer program product embodied in one or more non-transitory computer readable storage media storing computer readable and/or executable program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented at least partially in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may include a single instruction, or many instructions, and may even be distributed over several different code segments, among different programs, across several memory devices, or the like. Where a module or portions of a module are implemented in software, the software portions may be stored on one or more computer readable and/or executable storage media. Any combination of one or more computer readable storage media may be utilized. A computer readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

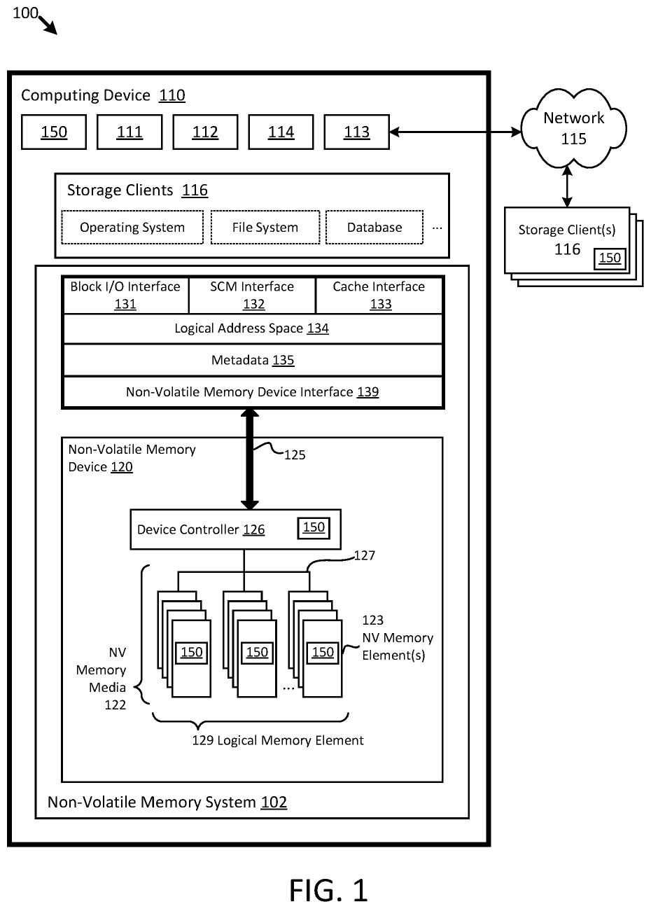

FIG. 1 depicts one embodiment of a system 100 comprising one or more temperature monitor components 150 for a non-volatile memory device 120. A temperature monitor component 150, in certain embodiments, may be configured to monitor and/or track different access frequencies for data received and/or stored by the non-volatile memory device 120 (e.g., write frequencies at which data is invalidated by new data, read frequencies, or the like). A temperature monitor component 150 may be configured to determine interleave metrics for blocks or other regions of the non-volatile memory device 120 based on the monitored access frequencies, indicating amounts, ratios, percentages or the like of data of the different access frequencies stored by the blocks or other regions.

A temperature monitor component 150, in some embodiments, may manage non-volatile memory media 122 of the non-volatile memory device 120 based on the interleave metrics (e.g., predicting subsequent interleave metrics based on the determined interleave metrics, selecting blocks or other regions for garbage collection or other storage capacity recovery operations, determining when to perform garbage collection or other storage capacity recovery operations, displaying a graphical representation of the interleave metrics to a user, or the like). In this manner, in certain embodiments, a temperature monitor component 150 may optimize and/or otherwise improve storage of data based on stream temperature, even if resources are not available to store each stream in a different open block or other region (e.g., in a memory card, automobile or other vehicle, or other embedded application with limited resources).

In one embodiment, a temperature monitor component 150 may include logic hardware of one or more non-volatile memory devices 120, such as a device controller 126, a non-volatile memory element 123, other programmable logic, firmware for a non-volatile memory element 123, microcode for execution by a non-volatile memory element 123, or the like. In another embodiment, a temperature monitor component 150 may include executable software code, stored on a computer readable storage medium for execution by a processor 111 and/or other logic hardware of a non-volatile memory element 123, a computing device 110, a storage client 116, or the like. In a further embodiment, a temperature monitor component 150 may include a combination of both executable software code and logic hardware.

A temperature monitor component 150, in various embodiments, may be part of, executing on, and/or integrated with one or more non-volatile memory elements 123, a device controller 126 external to the non-volatile memory elements 123, a device driver, a computing device 110, a storage client 116, or the like. Temperature monitor components 150 may be part of a non-volatile memory system 102 of a computing device 110, which may comprise a processor 111, volatile memory 112, and a communication interface 113. The processor 111 may comprise one or more central processing units, one or more general-purpose processors, one or more application-specific processors, one or more virtual processors (e.g., the computing device 110 may be a virtual machine operating within a host), one or more processor cores, or the like. The communication interface 113 may comprise one or more network interfaces configured to communicatively couple the computing device 110 and/or device controller 126 to a communication network 115, such as an Internet Protocol (IP) network, a Storage Area Network (SAN), wireless network, wired network, or the like.

The non-volatile memory device 120, in various embodiments, may be disposed in one or more different locations relative to the computing device 110. In one embodiment, the non-volatile memory device 120 comprises one or more non-volatile memory elements 123, such as semiconductor chips or packages or other integrated circuit devices disposed on one or more printed circuit boards, storage housings, memory cards, and/or other mechanical and/or electrical support structures. For example, the non-volatile memory device 120 may comprise one or more direct inline memory module (DIMM) cards, one or more expansion cards and/or daughter cards, a solid-state-drive (SSD) or other hard drive device, a memory card, and/or may have another memory and/or storage form factor. The non-volatile memory device 120 may be integrated with and/or mounted on a motherboard of the computing device 110, installed in a port and/or slot of the computing device 110, installed on a different computing device 110 and/or a dedicated storage appliance on the network 115, installed in a vehicle or other embedded application, in communication with the computing device 110 over an external bus (e.g., an external hard drive), or the like.

The non-volatile memory device 120, in one embodiment, may be disposed on a memory bus of a processor 111 (e.g., on the same memory bus as the volatile memory 112, on a different memory bus from the volatile memory 112, in place of the volatile memory 112, or the like). In a further embodiment, the non-volatile memory device 120 may be disposed on a peripheral bus of the computing device 110, such as a peripheral component interconnect express (PCI Express or PCIe) bus, a serial Advanced Technology Attachment (SATA) bus, a parallel Advanced Technology Attachment (PATA) bus, a small computer system interface (SCSI) bus, a FireWire bus, a Fibre Channel connection, a Universal Serial Bus (USB), a PCle Advanced Switching (PCIe-AS) bus, or the like. In another embodiment, the non-volatile memory device 120 may be disposed on a data network 115, such as an Ethernet network, an Infiniband network, SCSI RDMA over a network 115, a storage area network (SAN), a local area network (LAN), a wide area network (WAN) such as the Internet, another wired and/or wireless network 115, or the like.

The computing device 110 may further comprise a non-transitory, computer readable storage medium 114. The computer readable storage medium 114 may comprise executable instructions configured to cause the computing device 110 (e.g., processor 111) to perform steps of one or more of the methods disclosed herein.

In one embodiment, the non-volatile memory device 120 is configured to receive storage requests from a device driver or other executable application via buses 125, 127, a device controller 126, or the like. The non-volatile memory device 120 may be further configured to transfer data to/from a device driver and/or storage clients 116 via the bus 125. Accordingly, the non-volatile memory device 120, in some embodiments, may comprise and/or be in communication with one or more direct memory access (DMA) modules, remote DMA modules, bus controllers, bridges, buffers, and so on to facilitate the transfer of storage requests and associated data. In another embodiment, the non-volatile memory device 120 may receive storage requests as an API call from a storage client 116, as an IO-CTL command, or the like.

According to various embodiments, a device controller 126 may manage one or more non-volatile memory devices 120 and/or non-volatile memory elements 123. The non-volatile memory device(s) 120 may comprise recording, memory, and/or storage devices, such as solid-state storage device(s) and/or semiconductor storage device(s) that are arranged and/or partitioned into a plurality of addressable media storage locations. As used herein, a media storage location refers to any physical unit of memory (e.g., any quantity of physical storage media on a non-volatile memory device 120). Memory units may include, but are not limited to: pages, memory divisions, blocks, sectors, collections or sets of physical storage locations (e.g., logical pages, logical blocks), or the like.

A device driver and/or the device controller 126, in certain embodiments, may present a logical address space 134 to the storage clients 116. As used herein, a logical address space 134 refers to a logical representation of memory resources. The logical address space 134 may comprise a plurality (e.g., range) of logical addresses. As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

A device driver for the non-volatile memory device 120 may maintain metadata 135, such as a logical to physical address mapping structure, to map logical addresses of the logical address space 134 to media storage locations on the non-volatile memory device(s) 120. A device driver may be configured to provide storage services to one or more storage clients 116. The storage clients 116 may include local storage clients 116 operating on the computing device 110 and/or remote, storage clients 116 accessible via the network 115 and/or communication interface 113. The storage clients 116 may include, but are not limited to: operating systems, file systems, database applications, server applications, kernel-level processes, user-level processes, applications, and the like.

A device driver may be communicatively coupled to one or more non-volatile memory devices 120. The one or more non-volatile memory devices 120 may include different types of non-volatile memory devices including, but not limited to: solid-state storage devices, semiconductor storage devices, SAN storage resources, or the like. The one or more non-volatile memory devices 120 may comprise one or more respective device controllers 126 and non-volatile memory media 122. A device driver may provide access to the one or more non-volatile memory devices 120 via a traditional block I/O interface 131. Additionally, a device driver may provide access to enhanced functionality through the SCM interface 132. The metadata 135 may be used to manage and/or track data operations performed through any of the block I/O interface 131, SCM interface 132, cache interface 133, or other, related interfaces.

The cache interface 133 may expose cache-specific features accessible via a device driver for the non-volatile memory device 120. Also, in some embodiments, the SCM interface 132 presented to the storage clients 116 provides access to data transformations implemented by the one or more non-volatile memory devices 120 and/or the one or more device controllers 126.

A device driver may present a logical address space 134 to the storage clients 116 through one or more interfaces. As discussed above, the logical address space 134 may comprise a plurality of logical addresses, each corresponding to respective media locations the on one or more non-volatile memory devices 120. A device driver may maintain metadata 135 comprising any-to-any mappings between logical addresses and media locations, or the like.

A device driver may further comprise and/or be in communication with a non-volatile memory device interface 139 configured to transfer data, commands, and/or queries to the one or more non-volatile memory devices 120 over a bus 125, which may include, but is not limited to: a memory bus of a processor 111, a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCle Advanced Switching (PCIe-AS) bus, a network 115, Infiniband, SCSI RDMA, or the like. The non-volatile memory device interface 139 may communicate with the one or more non-volatile memory devices 120 using input-output control (IO-CTL) command(s), IO-CTL command extension(s), remote direct memory access, or the like.

The communication interface 113 may comprise one or more network interfaces configured to communicatively couple the computing device 110 and/or the device controller 126 to a network 115 and/or to one or more remote, network-accessible storage clients 116. The storage clients 116 may include local storage clients 116 operating on the computing device 110 and/or remote, storage clients 116 accessible via the network 115 and/or the communication interface 113. The device controller 126 is part of and/or in communication with one or more non-volatile memory devices 120. Although FIG. 1 depicts a single non-volatile memory device 120, the disclosure is not limited in this regard and could be adapted to incorporate any number of non-volatile memory devices 120.

The non-volatile memory device 120 may comprise one or more elements 123 of non-volatile memory media 122, which may include but is not limited to: resistive random access memory (ReRAM), Memristor memory, phase-change memory (PCM, PCME, PRAM, PCRAM, ovonic unified memory, chalcogenide RAM, or C-RAM), NAND flash memory (e.g., 2D NAND flash memory, 3D NAND flash memory), NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), programmable metallization cell (PMC), conductive-bridging RAM (CBRAM), magneto-resistive RAM (MRAM), magnetic storage media (e.g., hard disk, tape), optical storage media, or the like. The one or more elements 123 of non-volatile memory media 122, in certain embodiments, comprise storage class memory (SCM).

While legacy technologies such as NAND flash may be block and/or page addressable, storage class memory, in one embodiment, is byte addressable. In further embodiments, storage class memory may be faster and/or have a longer life (e.g., endurance) than NAND flash; may have a lower cost, use less power, and/or have a higher storage density than DRAM; or offer one or more other benefits or improvements when compared to other technologies. For example, storage class memory may comprise one or more non-volatile memory elements 123 of ReRAM, Memristor memory, programmable metallization cell memory, phase-change memory, nano RAM, nanocrystal wire-based memory, silicon-oxide based sub-10 nanometer process memory, graphene memory, SONOS memory, PMC memory, CBRAM, MRAM, and/or variations thereof.

While the non-volatile memory media 122 is referred to herein as “memory media,” in various embodiments, the non-volatile memory media 122 may more generally comprise one or more non-volatile recording media capable of recording data, which may be referred to as a non-volatile memory medium, a non-volatile storage medium, or the like. Further, the non-volatile memory device 120, in various embodiments, may comprise a non-volatile recording device, a non-volatile memory device, a non-volatile storage device, or the like. Similarly, a non-volatile memory element 123, in various embodiments, may comprise a non-volatile recording element, a non-volatile memory element, a non-volatile storage element, or the like.

The non-volatile memory media 122 may comprise one or more non-volatile memory elements 123, which may include, but are not limited to: chips, packages, planes, die, or the like. A device controller 126, external to the one or more non-volatile memory elements 123, may be configured to manage data operations on the non-volatile memory media 122, and may comprise one or more processors, programmable processors (e.g., FPGAs), ASICs, micro-controllers, or the like. In some embodiments, the device controller 126 is configured to store data on and/or read data from the non-volatile memory media 122, to transfer data to/from the non-volatile memory device 120, and so on.

The device controller 126 may be communicatively coupled to the non-volatile memory media 122 by way of a bus 127. The bus 127 may comprise an I/O bus for communicating data to/from the non-volatile memory elements 123. The bus 127 may further comprise a control bus for communicating addressing and other command and control information to the non-volatile memory elements 123. In some embodiments, the bus 127 may communicatively couple the non-volatile memory elements 123 to the device controller 126 in parallel. This parallel access may allow the non-volatile memory elements 123 to be managed as a group, forming a logical memory element 129. The logical memory element may be partitioned into respective logical memory units (e.g., logical pages) and/or logical memory divisions (e.g., logical blocks). The logical memory units may be formed by logically combining physical memory units of each of the non-volatile memory elements.

The device controller 126 may comprise and/or be in communication with a device driver executing on the computing device 110. A device driver may provide storage services to the storage clients 116 via one or more interfaces 131, 132, and/or 133. In some embodiments, a device driver provides a block-device I/O interface 131 through which storage clients 116 perform block-level I/O operations. Alternatively, or in addition, a device driver may provide a storage class memory (SCM) interface 132, which may provide other storage services to the storage clients 116. In some embodiments, the SCM interface 132 may comprise extensions to the block device interface 131 (e.g., storage clients 116 may access the SCM interface 132 through extensions or additions to the block device interface 131). Alternatively, or in addition, the SCM interface 132 may be provided as a separate API, service, and/or library. A device driver may be further configured to provide a cache interface 133 for caching data using the non-volatile memory system 102.

A device driver may further comprise a non-volatile memory device interface 139 that is configured to transfer data, commands, and/or queries to the device controller 126 over a bus 125, as described above.

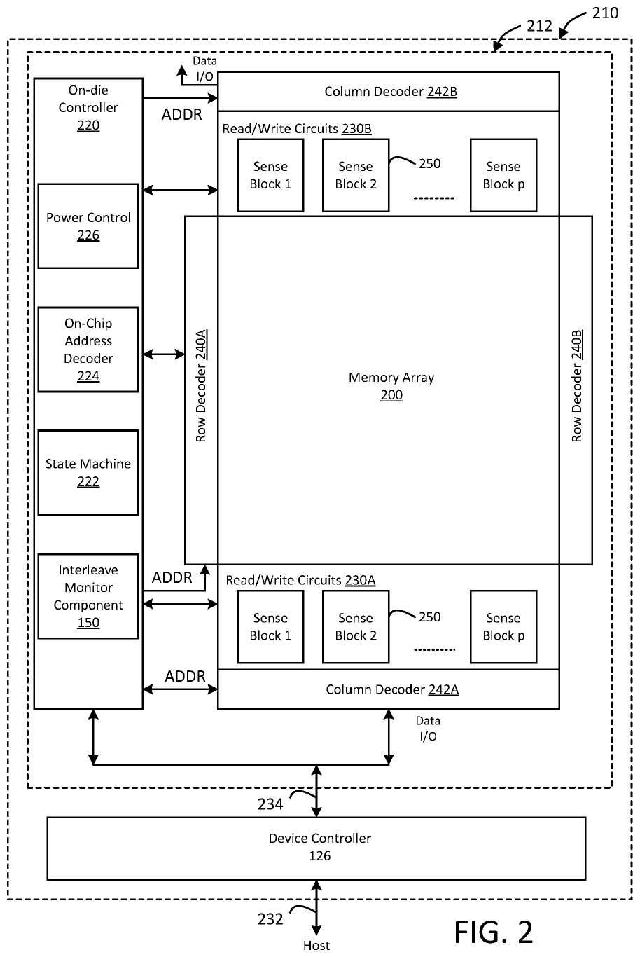

FIG. 2 illustrates an embodiment of a non-volatile storage device 210 that may include one or more memory die or chips 212. A memory die or chip 212 may be a non-volatile memory element 123 as described above with regard to FIG. 1. The non-volatile storage device 210 may be substantially similar to the nonvolatile memory device 120 described with reference to FIG. 1. Memory die 212, in some embodiments, includes an array (two-dimensional or three-dimensional) of memory cells 200, an on-die controller 220, and read/write circuits 230A/230B. In one embodiment, access to the memory array 200 by the various peripheral circuits is implemented in a symmetric fashion, on opposite sides of the array, so that the densities of access lines and circuitry on each side are reduced by half. The read/write circuits 230A/230B, in a further embodiment, include multiple sense blocks 250 which allow a page of memory cells to be read or programmed in parallel. In the depicted embodiment, peripheral circuits such as row decoders 240A/240B, column decoders 242A/242B, and read/write circuits 230A/230B are disposed at the edges of the memory array. In another embodiment, however, peripheral circuitry may be disposed above, below, and/or at the sides of a three-dimensional memory array 200.

The memory array 200, in various embodiments, is addressable by word lines via row decoders 240A/240B and by bit lines via column decoders 242A/242B. In some embodiments, a device controller 126 external to the memory die 212 is included in the same memory device 210 (e.g., a removable storage card or package) as the one or more memory die 212. Commands and data are transferred between the host and the device controller 126 via lines 232 and between the device controller 126 and the one or more memory die 212 via lines 234. One embodiment may include multiple chips 212.

On-die controller 220, in one embodiment, cooperates with the read/write circuits 230A/230B to perform memory operations on the memory array 200. The on-die controller 220, in certain embodiments, includes a state machine 222, an on-chip address decoder 224, a power control circuit 226, and a temperature monitor component 150, which may be substantially as described above with regard to FIG. 1. In various embodiments, a temperature monitor component 150 may include or be embodied by an on-die controller 220, a state machine 222, a device controller 126, and/or a device driver.

The state machine 222, in one embodiment, provides chip-level control of memory operations. The on-chip address decoder 224 provides an address interface to convert between the address that is used by the host or a device controller 126 to the hardware address used by the decoders 240A, 240B, 242A, 242B. The power control circuit 226 controls the power and voltages supplied to the word lines and bit lines during memory operations. In one embodiment, power control circuit 226 includes one or more charge pumps that can create voltages larger than the supply voltage.

In one embodiment, one or any combination of on-die controller 220, power control circuit 226, on-chip address decoder 224, state machine 222, temperature monitor component 150, decoder circuit 242A, decoder circuit 242B, decoder circuit 240A, decoder circuit 240B, read/write circuits 230A, read/write circuits 230B, and/or device controller 126 can be referred to as one or more managing circuits.

In certain embodiments, file systems may interact with a flash translation layer (FTL). As used herein, a flash translation layer may refer to a driver or controller that controls the flash memory as to cause a linear flash memory to appear to the file or operating system like a disk drive. To cause flash memory to appear as a disk drive, the FTL may create “virtual” small blocks of data out of the larger erase blocks of the flash memory. Also, the FTL may manage data on the flash memory such that it appears to be “write in place” when the managed data is actually stored in different locations in the flash memory. Further, the FTL may manage the flash memory so there are clean/erased places to store data.

In certain embodiments, a file system, as used herein may refer to a system that controls how data or units of data are stored and retrieved through interactions with the flash translation layer. As described herein, a unit of data or data may refer to information that has been codified so as to be storable in a computer readable medium. Further, the file system may manage files and perform operations on the files. In certain embodiments, the file system refers to a logical file system, where the file system is responsible for file and file-level operations between the memory and a user application. Further, the file system may pass requested operations to a flash translation layer for processing.

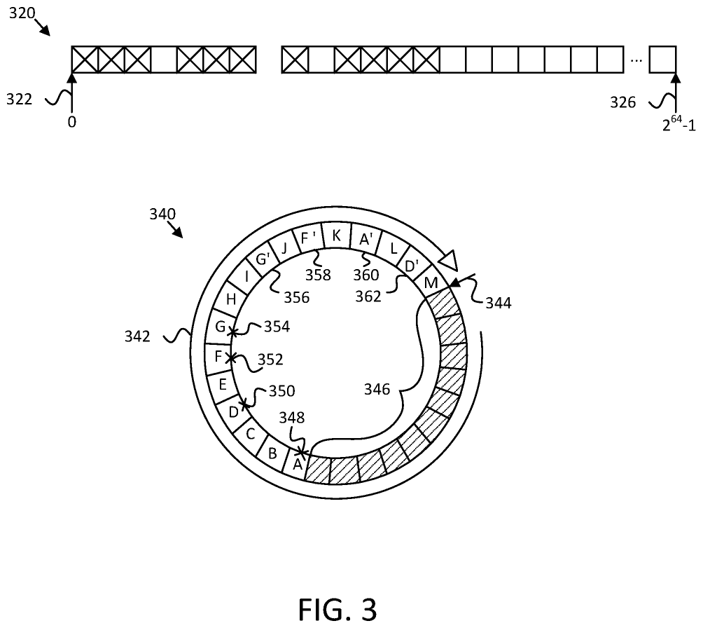

FIG. 3 depicts one embodiment of a logical address space 320, and a sequential, log-based, append-only writing structure 340. The logical address space 320 of the non-volatile memory device 120, in the depicted embodiment, may be larger than the physical storage capacity and corresponding storage device address space of the non-volatile memory device 120. In the depicted embodiment, the non-volatile memory device 120 has a 64-bit logical address space 320 beginning at logical address “0” 322 and extending to logical address “264-1” 326. As illustrated, the logical address space 320 may store data at the locations marked by an “X” and may have available locations for storing data at the locations lacking an “X”. Because the storage device address space corresponds to only a subset of the logical address space 320 of the non-volatile memory device 120, the rest of the logical address space 320 may be restricted or used for other functions of the non-volatile memory device 120.

The sequential, log-based, append-only writing structure 340, in the depicted embodiment, is a logical representation of the physical storage media 122 of the non-volatile memory device 120. In certain embodiments, the non-volatile memory device 120 stores data sequentially, appending data to the log-based writing structure 340 at an append point 344. Non-volatile storage media storing deallocated/unused logical blocks, in the depicted embodiment, is added to an available storage pool 346 for the non-volatile memory device 120. By clearing invalid data from the non-volatile memory device 120, and adding the physical storage capacity corresponding to the cleared data back to the available storage pool 346, in one embodiment, the log-based writing structure 340 is cyclic, ring-like, and has a theoretically infinite capacity.

In the depicted embodiment, the append point 344 progresses around the log-based, append-only writing structure 340 in a circular pattern 342 storing data “A” through “M”. In one embodiment, the circular pattern 342 wear balances the non-volatile memory media 122, increasing a usable life of the non-volatile memory media 122. In the depicted embodiment, the file system may mark several blocks 348, 350, 352, 354 as invalid, represented by an “X” marking on the blocks 348, 350, 352, 354. The file system and the flash translation layer, in one embodiment, may recover the physical storage capacity of the invalid blocks 348, 350, 352, 354 and may add the recovered capacity to the available storage pool 346. In the depicted embodiment, modified versions of the blocks 348, 350, 352, 354 have been appended to the log-based writing structure 340 as new blocks 356, 358, 360, 362 in a read, modify, write operation or the like, allowing the original blocks 348, 350, 352, 354 to be recovered.

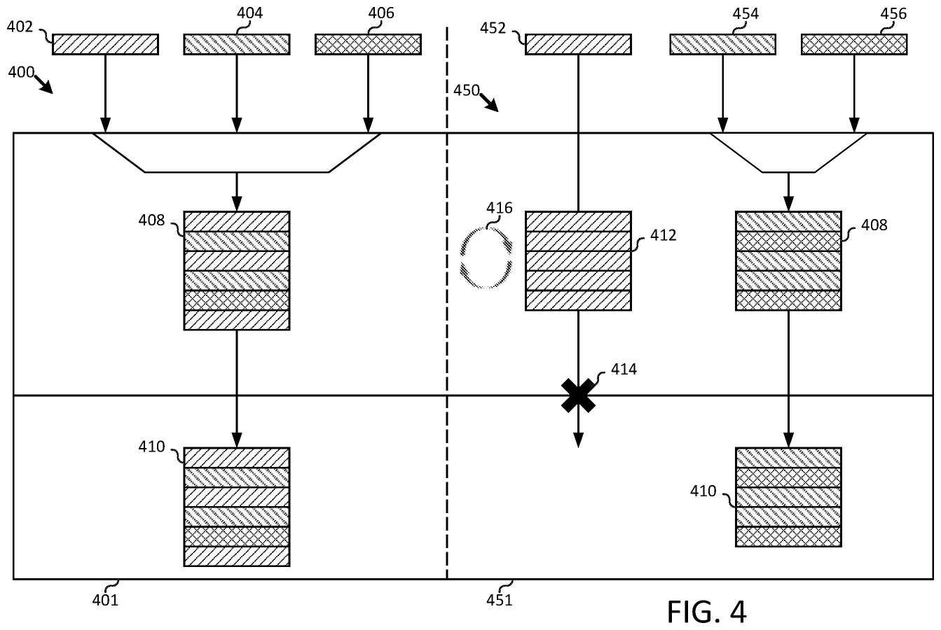

FIG. 4 illustrates different systems 400 and 450 for saving information from multiple streams into a memory medium 410. As shown, the system 400 may include a first stream 402, a second stream 404, and a third stream 406. The streams 402, 404, 406 may have different access frequencies (e.g., hot, warm, cold, unknown, or the like), may be labeled and/or categorized by a file system based on one or more factors, such as access frequency, interleave metrics, data type, or the like. For example, the data may be divided into a hot stream, a warm stream, a cold stream, or the like based on a frequency at which the data is expected to be updated and/or invalidated. Data in a hot stream 402 may be associated with frequently updated files, such as temporary files that are created and used during the life of a process, where the temporary files may be deleted and/or overwritten at the end of the process, or the like. Also, stream 404 may be a warm stream, where the data in the warm stream may be updated less frequently than data in the hot stream, or the like. Further, stream 406 may be a cold stream, where data in the cold stream may be infrequently updated, or the like.

In at least one embodiment, when data is divided into different streams 402, 404, 406 based on access frequency, interleave metrics, or the like, a file system may identify the access frequency based on a file type and/or other characteristic of the data. For example, a file system may determine that data is to be saved in a certain file, directory, or the like and associate that data with a hot stream 402. Alternatively, a file system may determine that data is to be saved as a different file type and associate that data with a warm stream 404. Further, a file system may determine that data is to be saved as a file type and/or in a directory associated with a cold stream 406. In some embodiments, a file system may associate data with a stream 402, 404, 406 based on an operation that created the data, historical access and/or usage of the data, or the like.

In certain embodiments, a file system, such as a flash friendly file system (F2FS), or the like may provide temperature indications, stream hints, and/or other indicators of access frequencies. For example, a file system may label data, data files, or the like as “hot,” “warm,” “cold,” “unknown,” or the like. In some embodiments, a file system may provide separate indicators of access frequencies for different types of data, such as user data and file system metadata (e.g., inode data, or the like), such as “hot user data,” “warm user data,” “cold user data,” “hot inode data,” “warm inode data,” “cold inode data,” “unknown data,” or the like. A file system may make indicators of access frequencies available to a temperature monitor component 150 in one or more log files and/or other data structures.

In certain embodiments, a flash translation layer 401 may translate logical addresses for the data associated with the streams 402, 404, 406 into physical addresses where the data is stored in a memory medium 410. In certain embodiments, the memory medium 410 may comprise a plurality of multi-level cells, where multiple bits may be stored per memory cell. A flash translation layer 401, in some embodiments, may store data in an intermediate memory 408 (e.g., either independently or temporarily before writing the data to the memory medium 410). In certain embodiments, the intermediate memory 408 may be a single level cell storage area where a memory cell stores a single bit per cell. In at least one embodiment, the intermediate memory 408 may act as a first-in-first-out (FIFO) buffer (e.g., to reduce the amount of obsolete data that is written into the memory medium 410, or the like). For example, obsolete data in the intermediate memory 408 may be invalidated without requiring relocation into the memory medium 410. Accordingly, frequently updated data may be replaced and its storage reused without the data being relocated to the memory medium 410.

In some embodiments, in order to minimize the copying back of data from the intermediate memory 408 to the memory medium 410, a temperature monitor component 150 (e.g., in cooperation with a flash translation layer 401, or the like) may store certain data (e.g., hot data, warm data, data with an access frequency that satisfies a threshold, data with an interleave metric indicating a ratio of hot data and/or warm data that satisfies a threshold, a predicted subsequent interleave metric indicating an expected ratio of hot data and/or warm data that satisfies a threshold, or the like) in a buffer memory 412 or first portion of the intermediate memory 408 (e.g., single level cells storing one bit per memory cell, or the like) without copying the data back to the memory medium 410 (e.g., multi-level cells storing multiple bits per memory cell, or the like), delaying copying the data back to the memory medium 410, or the like, in order to maximize a likelihood that the data is rewritten and invalidated while in the buffer memory 412 and/or the intermediate memory 408.

For example, the buffer memory 412 may be a block, a page, a die or other sized region of memory 412. In contrast to the rest of the intermediate memory 408, data stored in the buffer memory 412 may be prevented 414 and/or delayed 414 from being relocated into the memory medium 410. As data in the first portion of memory, the buffer memory area 412, is not relocated into the second portion of memory, the memory medium 410, and/or the relocation is delayed, the amount of data that is relocated into the memory medium 410 may be reduced as data is invalidated by subsequent writes. For example, system 450 may maintain three or more streams 452, 454, 456. Stream 452 may be a hot stream, stream 454 may be a warm stream, and stream 456 may be a cold stream. As described above, the stream 452 may be updated frequently.

In some embodiments, before translation from the logical addresses to the physical addressing by the flash translation layer 451, a file system may associate an access frequency with the data (e.g., in a log file, or the like) identifying to which stream 452, 454, 456 the data belongs. The flash translation layer 451 may then store data from different streams 452, 454, 456 to different open blocks or other regions of memory 408, 410, 412. For example, data associated with streams 454 and 456 may be stored in the intermediate memory 408 and subsequently relocated into the memory medium 410. Conversely, data associated with the stream 452 may be stored in the buffer memory 412, without being copied and/or written back to the memory medium 410 or being copied and/or written back to the memory medium 410 with a delay.

In some embodiments, due to resource constraints or the like, it may be impractical to maintain open blocks for each separate stream 402, 404, 406 and/or to determine access frequencies prior to storing the data. For example, certain embedded devices may use a single open block 408 for data to be written and a flash translation layer 451 may mix multiple streams 402, 404, 406 together into the single open block 408 or other region of memory, into two blocks 408, 410 or other regions of memory, or the like. For example, in system 400, data from multiple streams 402, 404, 406 may be mixed together into one open block 408 or other region of memory.

A temperature monitor component 150, in some embodiments, may monitor access frequencies for data (e.g., from a file system), determine interleave metrics for blocks or other regions of memory, and/or predict subsequent interleave metrics (e.g., predicting a composition and/or ratio of the different streams 402, 404, 406, or the like). For example, in response to predicting a subsequent interleave metric indicating that hot data, warm data, or the like is expected to satisfy a threshold, a temperature monitor component 150 and/or a flash translation layer 451 may selectively store data in an open block of single cell memory 408, 412, may delay garbage collection 416 and/or copying back to multi-cell memory 410, or the like. In response to predicting a subsequent interleave metric indicating that hot data, warm data, or the like is expected to fail to satisfy a threshold, that cold data is expected to satisfy a threshold, or the like, a temperature monitor component 150 and/or a flash translation layer 451 may selectively store data in an open block of multi-level cell memory 410, may perform a garbage collection operation 416, or the like.

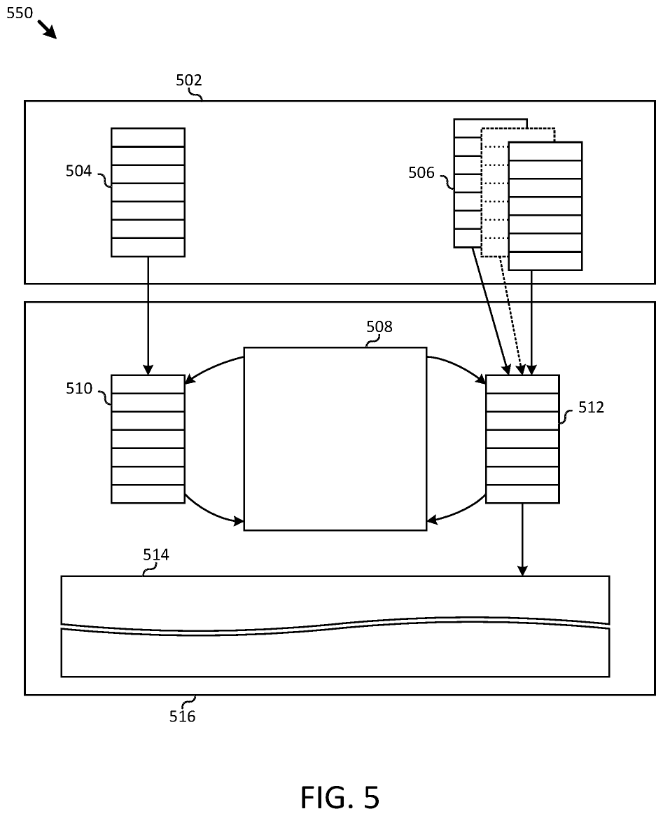

FIG. 5 illustrates one embodiment of a system 550 having a memory that stores data associated with a frequently updated log-based writing structure. As illustrated, system 550 may include a file system 502 and a flash translation layer 516. As described above, the file system 502 may control how data is stored and retrieved through interactions with the flash translation layer 516. As shown, the file system 502 may maintain different data structures 504 and 506 for the management of data units. For example, when the file system 502 receives a data unit, the file system 502 may classify the data and place it in one of the data structures 504 and 506 that is associated with the classification. In at least one embodiment, the file system 502 may classify the data units based on the frequency at which the data units are updated (e.g., an access frequency, or the like).

As described above, in certain embodiments, data units may be classified as “hot.” “warm,” “cold.” “unknown,” or the like where a hot data unit is updated most frequently, a cold data unit is updated the least frequently, and a warm data unit is updated at a rate between that of hot and cold data units. Accordingly, hot data units may be saved in a hot data structure 504, and warm and cold data units may be saved in warm and cold data structures 506, or the like. In at least one embodiment, the data structures 504 and 506 may be logical structures indicating temperature streams of different access frequencies. When the file system 502 writes data to one of the data structures 504 and 506, the file system 502 may associate an identifier of an access frequency to the data units (e.g., in a log file or the like).

In at least one embodiment, when data is written to the data structures 504 and 506, the flash translation layer 516 may translate the logical addresses of the data units for saving in physical locations of the memory medium 514. However, to avoid the saving of obsolete, invalidated data in the memory medium 514, the flash translation layer 516 may save the data units in either an intermediate memory 512 or a buffer memory 510 based on the access frequencies for the data units, determined interleave metrics, and/or predicted subsequent interleave metrics. For example, when a data unit is expected to have a high composition of hot data based on a predicted subsequent interleave metric, the flash translation layer 516 may save the data unit in the buffer memory 510. When a data unit is expected to have a high composition of warm and/or cold data based on a predicted subsequent interleave metric, the flash translation layer 516 may save the data unit in the intermediate memory 512, directly to the memory medium 514, or the like. The flash translation layer may relocate data units that are stored in the intermediate memory 512 into the memory medium 514 (e.g., subsequently at a later time, during a copyback operation, during a garbage collection or other storage capacity recovery operation, or the like).

In certain embodiments, the flash translation layer 516 may assign blocks or other regions of memory to the intermediate memory 512 and the buffer memory 510 from a common memory pool 508. As used herein, a region of memory may refer to a logical and/or physical portion of memory that may be assignable by the flash translation layer 516 to store data. For example, a region of memory may refer to a block of memory, or other divisible part of the memory. In at least one embodiment, where a region of memory is a memory block, the flash translation layer 516 may assign blocks of memory to the buffer memory 510 and the intermediate memory 512. In certain embodiments, where the file system 502 comprises F2FS, a size of a section for the file system 502 may be equal to a block.

In at least one embodiment, the flash translation layer 516 controls garbage collection (e.g., storage capacity recovery, or the like) for the buffer memory 510 and/or the intermediate memory 512. When recovering a block of memory from the buffer memory 510 and/or the intermediate memory 512, the flash translation layer 516 may identify the valid data in the block of memory and relocate the valid data into a fresh (e.g., erased) block of memory from the memory medium 514, from the common memory pool 508, or the like. The flash translation layer 516 may return the recovered block of memory back to the common memory pool for subsequent use.

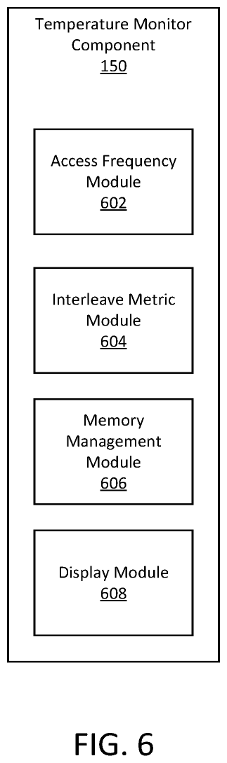

FIG. 6 depicts one embodiment of a temperature monitor component 150. The temperature monitor component 150 may be substantially similar to the temperature monitor component 150 described above with regard to FIGS. 1 and 2. In the depicted embodiment, the temperature monitor component 150 includes an access frequency module 602, an interleave metric module 604, a memory management module 606, and a display module 608. In various embodiments, a controller, such as an on-die controller 220 for a single non-volatile memory element 123, a device controller 126 for a device comprising one or more non-volatile memory elements 123, a device driver comprising executable code stored on a computer-readable storage medium, or the like, may include one or more of the access frequency module 602, the interleave metric module 604, the memory management module 606, and/or the display module 608.

In one embodiment, the temperature monitor component 150 comprises a device controller 126 disposed on a non-volatile memory device 120. In a further embodiment, the temperature monitor component 150 comprises executable code executing on a computing device 110, 116 and the non-volatile memory device 120 is configured to store metadata (e.g., log files, access frequencies, storage locations, or the like) in a location external to the non-volatile memory device 120 and accessible to the temperature monitor component 150 (e.g., over the data network 115, in a computer readable storage medium 114 of a computing device 110, or the like) enabling the temperature monitor component 150 to monitor different access frequencies and to determine interleave metrics for the non-volatile memory device 120.

The access frequency module 602, in one embodiment, is configured to monitor and/or otherwise track different access frequencies for data received and/or stored by by a non-volatile memory device 120. For example, in some embodiments, different access frequencies for data may be determined by a file system associated with the data (e.g., hot data, warm data, cold data, hot user data, warm user data, cold user data, hot inode data, warm inode data, cold inode data, unknown data, or the like) and the access frequency module 602 may monitor one or more log files and/or other metadata of the file system.

In a further embodiment, the access frequency module 602 may determine access frequencies based on another characteristic of the data. In a virtualization and/or multi-tenancy environment, in certain embodiments, each virtual function may comprise one or more streams, and some virtual functions may have a role which the access frequency module 602 may characterize as a specific access frequency. For example, a specific function may sequentially write at a high frequency, while another may be read-intensive with short random write bursts, or the like. In addition, some functions may use a F2FS file system while others may use a different filesystem which does not provide access frequencies or other hinting capabilities, or the like.

An access frequency, as used herein, comprises an indicator of an actual and/or predicted number of times data is accessed, is accessed by a predefined request and/or type of request, or the like. For example, in some embodiments, an access frequency comprises an update frequency at which data is likely to be invalidated by subsequent write data of a write request. In a further embodiment, an access frequency comprises a read frequency at which data is likely to be read in a read request, or the like. An access frequency may comprise a label or other indicator (e.g., hot, warm, cold, unknown), an actual and/or estimated number of accesses per unit of time (e.g., N times per minute, hour, day, week, and/or year), or the like.

The access frequency module 602, in some embodiments, may classify the data according to one or more measurable parameters. For example, measurable parameters may include the frequency at which the data is updated, the frequency at which the data is accessed, the data source, data type, or the like. In at least one embodiment, where the access frequency module 602 classifies the data based on the frequency at which the data is updated, the access frequency module 602 may determine that the data is either hot, warm, or cold, where hot data is updated the most frequently, warm data is updated less frequently, and the cold data is updated the least frequently.

The access frequency module 602, in one embodiment, is configured to determine the frequency with which data to be stored is updated. In at least one embodiment, the access frequency module 602 may determine how often data may be updated based on the type of data being saved. For example, the access frequency module 602 may determine whether data is an inode type or a user data type. When the access frequency module 602 determines that the data is an inode type, the access frequency module 602 may determine that the data will be updated frequently when the data is to be saved as a direct node block for a directory. Conversely, the access frequency module 602 may determine that the data will be updated less frequently when the data is to be saved as a direct node block for a regular file, an indirect node block, or the like. When the access frequency module 602 determines that the data is an inode data type, the access frequency module 602 may determine that the data will be updated frequently when the data is a directory entry block. Conversely, the access frequency module 602 may determine that the data will be updated less frequently when the data is a data block stored by a user, a data block moved by a garbage collection and/or storage capacity recovery operation, a multimedia file, or the like.

The interleave metric module 604, in one embodiment, is configured to determine interleave metrics indicating amounts of data of different access frequencies (e.g., from the access frequency module 602 or the like) stored by each of a plurality of blocks or other regions of a non-volatile memory device 120. An interleave metric, as used herein, comprises an indicator of an actual and/or estimated access frequency composition of a region of memory. For example, an interleave metric may comprise one or more percentages, ratios, data amounts (e.g., bytes, kilobytes, megabytes, gigabytes), or the like indicating a mix of data of different access frequencies interleaved together in a single region of memory.

The interleave metric module 604 may determine, store, and/or track interleave metrics on a per region basis (e.g., per logical or physical block, page, die, or other region). For example, the interleave metric module 604 may store interleave metrics per block within internal management tables of the non-volatile memory device 120, or the like.

The interleave metric module 604, in one embodiment, is configured to predict and/or estimate one or more subsequent interleave metrics based on previously determined interleave metrics. For example, the interleave metric module 604 may process previously determined interleave metrics to determine one or more patterns (e.g., using machine learning and/or other artificial intelligence) and predict a subsequent and/or next interleave metric (e.g., for data not yet received by the non-volatile memory device 120). The interleave metric module 604 may predict subsequent interleave metrics in real time, during runtime, or the like to enable the memory management module 606 to make management decisions for the non-volatile memory device 120 based on the predicted subsequent interleave metrics.

The memory management module 606, in one embodiment, is configured to perform one or more subsequent actions for a non-volatile memory device 120 based on determined interleave metrics and/or predicted subsequent interleave metrics from the interleave metric module 604, or the like. For example, in various embodiments, the memory management module 606 may determine to open one or more new blocks for writing, to separate streams according to access frequencies (e.g., temperature indications), to use fewer open blocks in parallel (e.g., to close one or more open blocks) in order to reduce overhead and/or release hardware resources for other tasks, or the like. For example, in embedded systems and/or other non-volatile memory devices 120 with limited resources, it may be difficult and/or impossible to maintain open blocks for each access frequency or other stream types. The memory management module 606, in some embodiments, may determine not to initiate and/or to avoid initiating garbage collection, copyback, and/or another storage capacity recovery operation based on a predicted subsequent interleave metric, or the like.

The memory management module 606, in one embodiment, performs a subsequent action comprising opening a number of regions (e.g., blocks) of the non-volatile memory device 120 for writing based on a predicted subsequent interleave metric. The memory management module 606, in a further embodiment, performs a subsequent action comprising postponing and/or delaying performance of garbage collection, copyback, and/or another storage capacity recovery operation for one or more regions (e.g., blocks) of the non-volatile memory device 120 based on a predicted subsequent interleave metric.

The memory management module 606, in certain embodiments, performs a subsequent action comprising selecting a region (e.g., block) of the non-volatile memory device 120 storing a single bit per memory cell (e.g., SLC) for storing data, as an open block, or the like in response to a predicted subsequent interleave metric satisfying a threshold. The memory management module 606, in a further embodiment, performs a subsequent action comprising selecting a region (e.g., block) of the non-volatile memory device 120 storing multiple bits per cell (e.g., MLC. TLC, or the like) in response to a predicted subsequent interleave metric failing to satisfy a threshold. In this manner, in various embodiments, the memory management module 606 may determine to store data with a higher mix of high frequency access data (e.g., hot data, warm data, or the like) in single level cells and/or to store data with a lower mix of high frequency access data (e.g., warm data, cold data, or the like) in multi-level cells, or the like.

The memory management module 606, in one embodiment, performs a subsequent action comprising retaining and/or keeping data stored in a region (e.g., block) of the non-volatile memory device 120 storing a single bit per memory cell in response to the predicted subsequent interleave metric satisfying a threshold (e.g., delaying garbage collection, a copyback operation, and/or another storage capacity recovery operation if high frequency access data is expected, or the like, since the data is expected to be invalidated soon).

The memory management module 606, in some embodiments, performs a subsequent action comprising copying back data from a region (e.g., block) storing a single bit per memory cell to a different region (e.g., block) storing multiple bits per cell in response to a predicted subsequent interleave metric failing to satisfy a threshold (e.g., performing garbage collection, a copyback operation, and/or another storage capacity recovery operation if low frequency access data is expected, or the like, since the data is not expected to be invalidated soon).

The memory management module 606, in certain embodiments, may redirect some ranges of data to a single level cell region (e.g., buffer) and write other ranges of data to a multi-level cell region based on a predicted subsequent interleave metric for the ranges of data, or the like. The memory management module 606 may subsequently separate highly interleaved single level cell regions (e.g., blocks) into multi-level cell regions (e.g., blocks) that are less interleaved (e.g., copying back data based on access frequency, or the like).

The memory management module 606, in one embodiment, may perform a subsequent action comprising selecting two or more of regions (e.g., blocks) for merging and/or interleaving during garbage collection, copyback, and/or another storage capacity recovery operation based on determined interleave metrics, predicted subsequent interleave metrics, or the like. For example, the memory management module 606 may keep regions (e.g., blocks) of data together that have similar interleave metrics, may split data between regions (e.g., blocks) according to access frequency, or the like.

The memory management module 606, in some embodiments, may select a region (e.g., block) for garbage collection, copyback, and/or another storage capacity recovery operation based on the determined interleave metrics and/or a predicted subsequent interleave metric. For example, the memory management module 606 may select a region (e.g., block) with an interleave metric that is an outlier from the interleave metrics of other regions, an outlier from a predicted subsequent interleave metric, or the like, may proactively recover storage capacity to free up regions (e.g., blocks) in order to accommodate an expected influx of data with a certain predicted subsequent interleave metric, or the like.

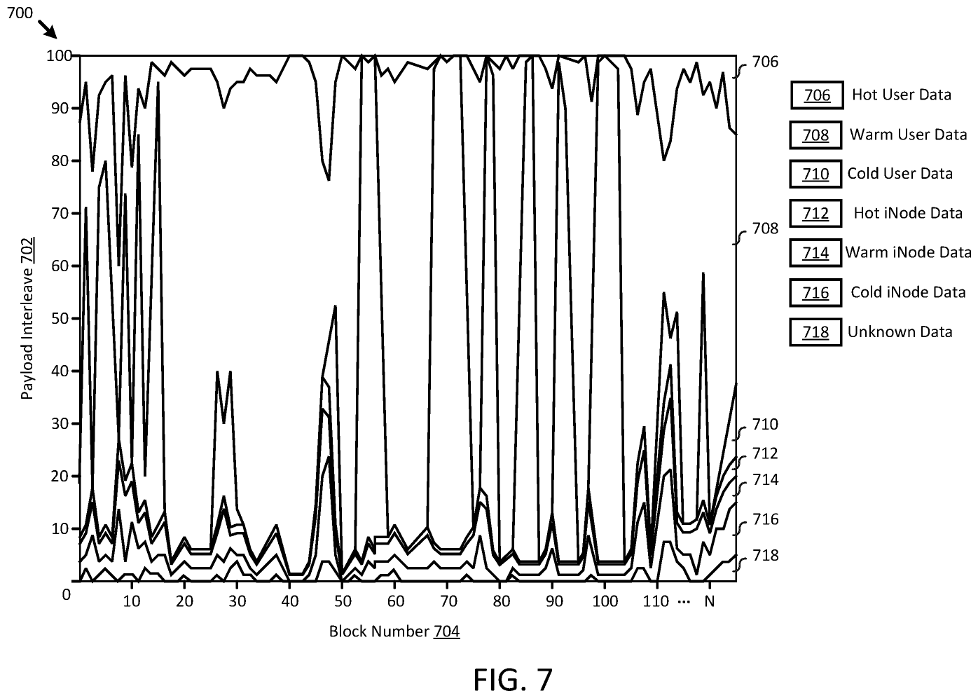

In one embodiment, the memory management module 606 may cooperate with the display module 608, and a subsequent action may comprise displaying, on an electronic display device of a computing device 110, 116 or the like, a graphical representation of determined interleave metrics for a plurality of regions (e.g., blocks) of a non-volatile memory device 120. One example of a graphical representation that the display module 608 may display is described below with regard to FIG. 7.

The display module 608, in some embodiments, may display a graphical representation comprising a histogram, stacked chart, mountain chart, and/or another graph of the different access frequencies indexed by the plurality of regions (e.g., by block numbers, or the like). For example, the display module 608 may display a graph visualizing access frequencies in a manner that shows quantitatively a mix level of different access frequencies (e.g., temperatures) written to regions (e.g., blocks) of a pre-programmed size determined by the product architecture, or the like. Because regions (e.g., blocks), in one embodiment, may be written sequentially, contiguous regions/blocks in a graph of the display module 608 may also be contiguous in time, allowing the interleave metric module 604 to predict subsequent access frequencies, interleave metrics, or the like and the memory management module 606 to make management decisions based thereon.

The display module 608, in one embodiment, may display a graphical representation of determined interleave metrics to an administrator, developer, and/or other user for the non-volatile memory device 120. The graphical representation may enable the user to visualize current and/or previous workloads for the non-volatile memory device 120, access frequency mixes, estimate and/or diagnose performance of the non-volatile memory device 120, determine one or more settings and/or maintenance decisions for the non-volatile memory device 120, or the like.

FIG. 7 depicts one embodiment of a graphical representation 700 of interleave metrics 702 for a non-volatile memory device 120. In the depicted embodiment, the graphical representation 700 depicts the interleave metrics 702 indexed by block number 704 (e.g., blocks 0−N). The interleave metrics 702, in the graphical representation 700, are represented as percentages and/or ratios of composition of each block in a histogram (e.g., a stacked chart, mountain chart, or the like).

The interleave metrics 702, in the depicted embodiment, include access frequencies comprising hot user data 706, warm user data 708, cold user data 710, hot inode data 712, warm inode data 714, cold inode data 716, and unknown data 718. While the depicted graphical representation 700 comprises a black and white line drawing, in other embodiments, each ratio and/or portion of interleaved data of a particular access frequency 706, 708, 710, 712, 714, 716, 718 may be represented by a different color, pattern, or the like to facilitate visualization of the interleave metrics 702.

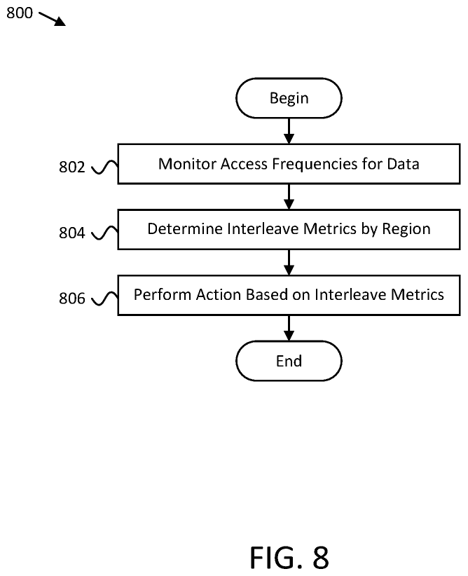

FIG. 8 depicts one embodiment of a method 800 for stream temperature interleave monitoring. The method 800 begins, and an access frequency module 602 monitors 802 different access frequencies for data received by a non-volatile memory device 120. An interleave metric module 604 determines 804 interleave metrics indicating amounts of data of the different access frequencies stored by each of a plurality of regions of the non-volatile memory device 120. A memory management module 606 performs a subsequent action for the non-volatile memory device 120 based on the determined 804 interleave metrics and the method 800 ends.

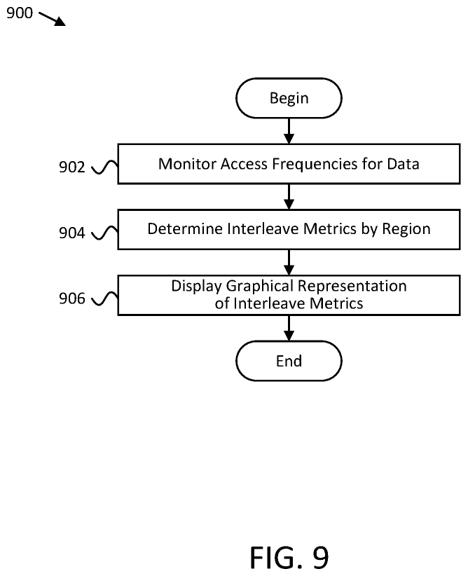

FIG. 9 depicts one embodiment of a method 900 for stream temperature interleave monitoring. The method 900 begins, and an access frequency module 602 monitors 902 different access frequencies for data received by a non-volatile memory device 120. An interleave metric module 604 determines 904 interleave metrics indicating amounts of data of the different access frequencies stored by each of a plurality of regions of the non-volatile memory device 120. A display module 608 displays, on an electronic display device, a graphical representation of the determined 904 interleave metrics for each of the plurality of regions and the method 900 ends.

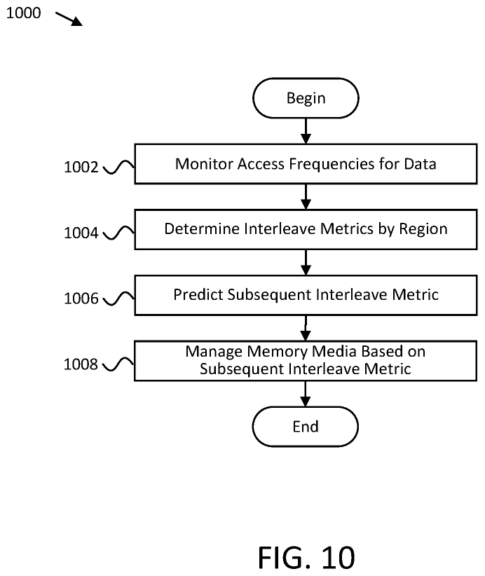

FIG. 10 depicts one embodiment of a method 1000 for stream temperature interleave monitoring. The method 1000 begins, and an access frequency module 602 monitors 1002 different access frequencies for data received by a non-volatile memory device 120. An interleave metric module 604 determines 1004 interleave metrics indicating amounts of data of the different access frequencies stored by each of a plurality of regions of the non-volatile memory device 120. An interleave metric module 606 predicts 1006 a subsequent interleave metric based on the determined 1004 interleave metrics. An interleave metric module 606 manages 1008 one or more operations on a non-volatile memory medium 122 of the non-volatile memory device 120 based on the predicted 1006 subsequent interleave metric and the method 1000 ends.

In various embodiments, a means for monitoring different access frequencies for data received by a non-volatile memory device 120 may include a temperature monitor component 150, an access frequency module 602, a file system, a log file, a state machine 222, an on-die controller 220, a device controller 126, a device driver, a processor 111, a storage client 116, a non-volatile memory device 120, a computing device 110, other logic hardware and/or other executable code stored on a computer readable storage medium. Other embodiments may include similar or equivalent means for monitoring different access frequencies for data received by a non-volatile memory device 120.

In various embodiments, a means for determining interleave metrics indicating amounts of data of different access frequencies stored by each of plurality of regions of non-volatile memory may include a temperature monitor component 150, an interleave metric module 604, a state machine 222, an on-die controller 220, a device controller 126, a device driver, a processor 111, a storage client 116, a non-volatile memory device 120, a computing device 110, other logic hardware and/or other executable code stored on a computer readable storage medium. Other embodiments may include similar or equivalent means for determining interleave metrics indicating amounts of data of different access frequencies stored by each of plurality of regions of non-volatile memory.

In various embodiments, a means for performing a subsequent action for a non-volatile memory device 120 based on determined interleave metrics may include a temperature monitor component 150, an memory management module 602, a state machine 222, an on-die controller 220, a device controller 126, a device driver, a processor 111, a storage client 116, a non-volatile memory device 120, an electronic display device, a computing device 110, other logic hardware and/or other executable code stored on a computer readable storage medium. Other embodiments may include similar or equivalent means for performing a subsequent action for a non-volatile memory device 120 based on determined interleave metrics. A means for performing a subsequent action, in certain embodiments, comprises means for displaying a graphical representation of determined interleave metrics for each of a plurality of regions.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. An apparatus comprising:
a non-volatile memory device comprising a plurality of regions of non-volatile memory; and
a controller configured to:
monitor different access frequencies for data received by the non-volatile memory device;
determine interleave metrics indicating amounts of data of the different access frequencies stored by each of the plurality of regions of the non-volatile memory; and
perform a subsequent action for the non-volatile memory device based on the determined interleave metrics.

2. The apparatus of claim 1, wherein the subsequent action comprises displaying, on an electronic display device, a graphical representation of the determined interleave metrics for each of the plurality of regions.

3. The apparatus of claim 2, wherein the graphical representation comprises a histogram of the different access frequencies indexed by the plurality of regions.

4. The apparatus of claim 1, wherein the controller is further configured to predict a subsequent interleave metric based on the determined interleave metrics.

5. The apparatus of claim 4, wherein performing the subsequent action for the non-volatile memory device is based on the predicted subsequent interleave metric.

6. The apparatus of claim 5, wherein the subsequent action comprises opening a number of the regions of the non-volatile memory for writing, the number of the regions opened selected based on the predicted subsequent interleave metric.

7. The apparatus of claim 4, wherein the subsequent action comprises postponing performance of a storage capacity recovery operation for one or more of the regions of the non-volatile memory device based on the predicted subsequent interleave metric.

8. The apparatus of claim 4, wherein the subsequent action comprises:
selecting a region of the regions of the non-volatile memory device storing a single bit per memory cell in response to the predicted subsequent interleave metric satisfying a threshold;
selecting a region of the regions of the non-volatile memory device storing multiple bits per cell in response to the predicted subsequent interleave metric failing to satisfy the threshold; and
storing subsequent data in the selected region.

9. The apparatus of claim 4, wherein the subsequent action comprises:
retaining data stored in a region of the regions of the non-volatile memory device storing a single bit per memory cell in response to the predicted subsequent interleave metric satisfying a threshold; and
copying back the data from the region storing a single bit per memory cell to a different region of the regions of the non-volatile memory device storing multiple bits per cell in response to the predicted subsequent interleave metric failing to satisfy the threshold.

10. The apparatus of claim 1, wherein the subsequent action comprises selecting two or more of the regions of the non-volatile memory device for merging in a storage capacity recovery operation based on the determined interleave metrics.

11. The apparatus of claim 1, wherein the subsequent action comprises selecting one of the plurality of regions of the non-volatile memory for a storage capacity recovery operation based on the determined interleave metrics.

12. The apparatus of claim 11, wherein an interleave metric for the selected one of the plurality of regions is an outlier from other interleave metrics of the determined interleave metrics.

13. The apparatus of claim 1, wherein the different access frequencies for the data are determined by a file system associated with the data and monitoring the different access frequencies comprises monitoring one or more log files of the file system.

14. The apparatus of claim 1, wherein the different access frequencies comprise update frequencies at which the data is invalidated by subsequent write data.

15. The apparatus of claim 1, wherein the controller comprises executable code executing on a computing device and the non-volatile memory device is configured to store metadata in a location external to the non-volatile memory device and accessible to the controller, the metadata enabling the controller to monitor the different access frequencies and to determine the interleave metrics.

16. The apparatus of claim 1, wherein the controller comprises a device controller disposed on the non-volatile memory device.

17. A method comprising:
tracking different access frequencies for data stored by a non-volatile memory device comprising a plurality of blocks;
determining ratios of interleaved data of the different access frequencies stored by each of the plurality of blocks; and
performing an action for the non-volatile memory device based on the determined ratios of interleaved data.

18. The method of claim 17, wherein the action comprises displaying, on an electronic display device, a graphical representation of the determined ratios of interleaved data for each of the plurality of blocks.

19. An apparatus comprising:
means for monitoring different access frequencies for data received by a non-volatile memory device comprising a plurality of regions of non-volatile memory;
means for determining interleave metrics indicating amounts of data of the different access frequencies stored by each of the plurality of regions of the non-volatile memory; and
means for performing a subsequent action for the non-volatile memory device based on the determined interleave metrics.

20. The apparatus of claim 19, wherein the means for performing the subsequent action comprises means for displaying a graphical representation of the determined interleave metrics for each of the plurality of regions.
